(19) United States
(12) Patent Application Publication
(10) Pub. No.: US 2026/0268736 A1
(43) Pub. Date: Sep. 10, 2026

(54) FRONT MONEY ACCOUNT INTEGRATED WITH GAMING ESTABLISHMENT ACCOUNT MANAGEMENT SYSTEM

(71) Applicant: IGT, Las Vegas, NV (US)

(72) Inventors: Jeffery Shepherd, Reno, NV (US); Kevin Higgins, Reno, NV (US)

(21) Appl. No.: 19/659,713

(22) Filed: Apr. 27, 2026

Related U.S. Application Data
(63) Continuation of application No. 17/964,654, filed on Oct. 12, 2022.

(51) Int. Cl. G07F 17/32; G06Q 20/20; G06Q 20/40

(52) U.S. Cl. CPC G07F 17/3251; G06Q 20/20; G06Q 20/4014; G07F 17/3223

(57) ABSTRACT

Systems and methods that integrate a front money account funded with front money provided by a user with one or more gaming establishment accounts associated with the user.

### PRIORITY CLAIM

This application is a continuation of, claims the benefit of and priority to U.S. patent application Ser. No. 17/964,654, filed on Oct. 12, 2022, the entire contents of which is incorporated by reference herein

### BACKGROUND

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIGS. 2A, 2B, 2C and 2D are flow charts of example processes for operating a system which integrates a front money account with a gaming establishment account.

### DETAILED DESCRIPTION

In various embodiments, the systems and methods of the present disclosure integrate a front money account funded with front money provided by a user with one or more gaming establishment accounts associated with the user

In certain embodiments, the system of the present disclosure links or otherwise associates a front money account with one or more gaming establishment accounts maintained by a gaming establishment fund management system. Such linkage or association enables funds deposited into the front money account to be transferred between the front money account and one or more of the gaming establishment accounts. In certain such embodiments, the transfer of funds to and/or from the front money account and a gaming establishment account may be initiated (automatically or responsive to one or more inputs) in association with the front money account. In these embodiments, while the gaming establishment accounts may receive funds from the front money account and transfer funds to the front money account, the initiation of such transfers originates in association with the front money account, such as from a gaming establishment front money handling system (and not from the gaming establishment account nor the gaming establishment fund management system). Such a one-way configuration enables control of any funding initiatives to remain with the components that maintain the front money account (which certain users of front money accounts prefer as they may be unfamiliar with the operation of the greater gaming establishment fund management system capabilities). In certain other embodiments, the transfer of funds to and/or from the front money account and a gaming establishment account may be initiated (automatically or responsive to one or more inputs) in association with the front money account and/or the gaming establishment account. In these embodiments, the initiation of the transfer of funds to and from the gaming establishment account and the front money account originates in association with the front money account and/or the gaming establishment account. Such a configuration provides that funds may seamlessly flow between these different accounts on demand to take full advantage of the gaming establishment fund management system capabilities.

Accordingly, in view of the different channels of commerce available in association with a gaming establishment and further in view of certain of these different channels of commerce each being associated with a separate account that holds funds to facilitate transactions within that channel of commerce, the system enables an amount of funds from a front money account funded with front money provided by the user to be transferred to one or more other accounts associated with one or more other channels of commerce associated with the gaming establishment. In these embodiments, following a deposit of funds into a front money account associated with a user, part or all of such funds are transferred (automatically and/or upon one or more user inputs) to one or more other accounts, such as to a cashless wagering account or a gaming establishment retail account. For example, in anticipation of a transfer of an amount of funds from a cashless wagering account to an electronic gaming machine, upon a determination that an amount of front money has been deposited into a front money account associated with a user, a component of the front money system that maintains the front money account (and/or a component of a cashless wagering system that maintains a cashless wagering account) initiates a transfer of part or all of the front money to the cashless wagering account. Such a transfer of front money from an existing front money account (or a replacement front money account maintained by the gaming establishment fund management system) to another account facilitates a more cashless and ticketless gaming establishment environment which equates to a relatively safer gaming establishment environment (e.g., minimizing users and/or gaming establishment personnel having to carry large sums of cash or ticket vouchers associated with large sums of money and minimizing such cash and/or ticket vouchers being vehicles to spread potentially harmful contagions). Such a configuration further reduces the use of paper ticket vouchers (which a gaming establishment cage may issue against front money provided for use at a gaming device) thus reducing the amount of waste produced by gaming establishments (and realizing an environmental benefit of implementing the system of the present disclosure).

Moreover, in certain embodiments, in view of the friction encountered by certain users in having certain transactions at a gaming establishment device declined due to inadequate funds in a gaming establishment account to complete a requested transaction, the system accesses an amount of funds from a front money account funded with front money provided by the user. In these embodiments, rather than denying a requested transaction if a single funding source lacks the requested amount of funds to complete the requested transaction, the system of the present disclosure coordinates obtaining the requested amount of funds from multiple funding sources (i.e., front money previously provided by a user and funds from a gaming establishment account maintained for that user) to complete a requested transaction at a gaming establishment device. For example, if a user requests to complete a purchase at a gaming establishment point-of-sale retail terminal (i.e., a gaming establishment device) and the front money system and/or a retail wallet system determines that a gaming establishment retail account associated with that user lacks adequate funds to complete the requested purchase, the system accesses an amount of user provided front money to fund the deficiency in the gaming establishment retail account and completes the requested purchase. In another example, if a user requests to transfer an amount of funds from a cashless wagering account to an electronic gaming machine and the system determines that the cashless wagering account associated with that user lacks adequate funds to complete the requested transfer, the front money handling system and/or the cashless wagering system accesses an amount of user provided front money to fund the deficiency in the cashless wagering account and completes the requested transfer. Such a configuration provides the user greater control over their funds, such as providing the user with the ability to complete a transaction at a gaming establishment device such as a non-gaming device (e.g., a retail point-of-sale terminal) or a gaming device (e.g., an electronic gaming machine (“EGM”) or a gaming table component associated with a gaming establishment gaming table) wherein part of the funds associated with such a transaction are accessed from front money.

As such and in view of the various funding options, transfer options and spending options associated with various accounts (including front money accounts and non-front money accounts) maintained by different components, the system of the present disclosure interconnects these different components (i.e., different wallet systems) to present a single view of an enterprise account (i.e., an enterprise wallet balance) to a user. Such a system thus facilitates the transacting between the various components (i.e., the various wallet systems) to deliver a user access to, amongst other funding sources, funds from a front money account, while tracking the transactions which occur amongst the different components. As such, the system provides that one or more front money accounts are connectable to the different accounts of the eco-system of disparate components across one or more different sites and/or one or more different gaming and non-gaming vertical boundaries to enable improved access to funds deposited into a front money account (which certain users may be familiar with) to facilitate use of such funds at the one or more different sites and/or with the one or more different gaming and non-gaming vertical boundaries (which those certain users may not be familiar with but could benefit from).

In various embodiments, the present disclosure is directed to a gaming establishment fund management system including various sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user, such as a retail patron, collectively form a resort or enterprise account (i.e., an integrated resort or gaming establishment fund management wallet) that the user may access to transfer funds and/or view balance information amongst the various accounts associated with or otherwise maintained for the user.

In various embodiments, the gaming establishment fund management system includes or is otherwise associated with one or more cashless wagering systems. Each cashless wagering system is associated with or otherwise maintain one or more cashless wagering accounts. In different embodiments, zero, one or more of these cashless wagering accounts are associated with (or otherwise configured to be associated with upon one or more inputs from a user and/or gaming establishment personnel) a front money account including front money provided by the user.

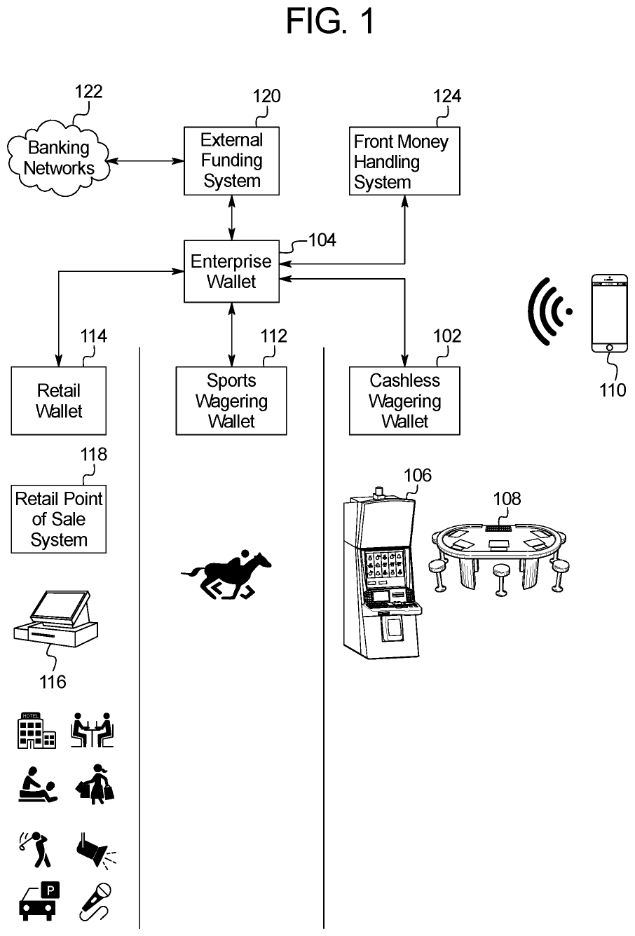

In certain embodiments, the gaming establishment fund management system includes a first cashless wagering system that maintains a first cashless wagering account. In these embodiments, a user, such as a player of an EGM, utilizes a mobile device application running on a mobile device and/or a physical instrument (e.g., a smart card or a user issued magnetic striped card which the user utilizes via inserting the card into a player tracking unit associated with the EGM) to facilitate the electronic transfer of any funds between this first cashless wagering account and a gaming device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise associated with a second cashless wagering system that maintains a second cashless wagering account. In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise associated with one or more gaming establishment retail wallet systems that each maintain one or more gaming establishment retail accounts. In different embodiments, zero, one or more gaming establishment retail accounts are associated with (or otherwise configured to be associated with upon one or more inputs from a user and/or gaming establishment personnel) a front money account including front money provided by the user.

In certain embodiments, such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In certain embodiments, the gaming establishment fund management system is in communication with one or more external funding sources which maintain one or more external accounts for the user. For example, as seen in FIG. 1, the gaming establishment fund management system that maintains the enterprise wallet 104 is in communication with an external funding system 120 which is in communication with a network of one or more banks or other financial institutions (i.e., the banking networks 122) which operate to electronically transfer funds between the user's accounts maintained at such banks or financial institutions and one or more of the accounts maintained by the gaming establishment fund management system. In certain embodiments, such external accounts include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any system or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes a front money handling system. In certain other embodiments, the gaming establishment fund management system is additionally or alternatively in communication with an external front money handling system. In these embodiments, the front-money handling system maintains one or more front money accounts for a user. Such a front money account is associated with an amount of front money provided by the user for use at one or more channels of commerce associated with the gaming establishment. For example, as seen in FIG. 1, the gaming establishment fund management system that maintains the enterprise wallet 104 is in communication with a gaming establishment front money handling system (i.e., the front money handling system 124) to facilitate the access of an amount of funds via front money provided by the user. Such front money is provided by the user, such as via the user depositing cash, gaming table chips, a personal check, a bank draft, a money order, an electronic funds transfer, or a wire transfer into a front money account (e.g., a front money wallet) associated with the user. In certain instances, the balance of the front money is drawn down from the front money account (in certain instances via the issuance of markers) and accessible by the front money handling system to, either directly or indirectly through a cashless wagering account, a credit balance of a gaming device, such as an EGM 106 and/or a gaming table 108a. In certain instances, the balance of the front money is additionally or alternatively drawn down from the front money account (in certain instances via the issuance of markers) and accessible by the front money handling system to, either directly or indirectly through a gaming establishment retail account, a point-of-sale terminal 116 (or an account associated with the point-of-sale terminal). It should be appreciated that while illustrated as the gaming establishment fund management system being in communication with one or more front money handling systems, in different embodiments, any system or sub-system of the present disclosure can be in communication with one or more front money handling systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment front money handling system.

In certain embodiments (not shown), the gaming establishment fund management system is in communication with one or more credit systems which each issue the user one or more lines of credit. These lines of credit are accessible to facilitate a transfer of funds from the line of credit issued by the credit system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal). It should be appreciated that the gaming establishment fund management system may be in communication with one or more credit systems, and in different embodiments, any system or sub-system of the present disclosure can be in communication with one or more credit systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments (not shown), the gaming establishment fund management system is also in communication with one or more credit reporting/credit risk systems which monitor and report on various accounts associated with the user. For example, the gaming establishment fund management system that maintains the enterprise wallet is in communication with one or more credit reporting and risk systems. These credit reporting and risk systems monitor and report on a credit rating and status of one or more accounts maintained for the user at various funding sources, such as various financial institutions. It should be appreciated that while, in certain embodiments, the gaming establishment fund management system being in communication with one or more credit reporting networks and one or more credit reporting/credit risk systems, in different embodiments, any system or sub-system of the present disclosure can be in communication with one or more credit reporting/credit risk systems.

In certain embodiments, the gaming establishment fund management system is in communication with one or more gaming establishment patron management systems (not shown) that monitor activities at various points of contact associated with the gaming establishment and provides rewards, such as redeemable player tracking points, in association with such activities. It should be appreciated that while, in certain embodiments, the gaming establishment fund management system is in communication with one or more gaming establishment patron management systems, in different embodiments, any system or sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments, the system utilizes one mobile device application to interact with the different components of the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

It should be appreciated that in different embodiments, in addition to or alternatively from utilizing a mobile device running a mobile device application to, amongst other actions, access funds associated with different gaming establishment accounts, the system utilizes a kiosk, a gaming device (e.g., an interface of an EGM or gaming table component), a service window displayed by a gaming establishment device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, access the funds associated with such gaming establishment accounts. It should be further appreciated that while illustrated in FIG. 1 as using a mobile device running a mobile device application to access funds associated with different gaming establishment accounts (e.g., a cashless wagering account and a gaming establishment retail account) as mentioned above, a physical instrument, such as a smart card or a user issued magnetic striped card may additionally or alternatively be utilized to enable a user access to such gaming establishment account.

In certain embodiments, the system enables a transfer of funds, such as front money funds, between a front money account and different accounts maintained by different components associated with different gaming activities and/or non-gaming activities. In these embodiments, the system employs a service for interfacing with the various components to facilitate balance inquiry and transferring funds amongst the different accounts maintained by these various components. In certain embodiments, such a service collects data from various components and utilizes such collected data to provide a singular view of the balances (or a plurality of singular views of different groupings of balances). In certain embodiments, such a service additionally or alternatively provides facilities to enforce rules associated with the different accounts maintained by the various components. In different such embodiments, these rules include, but are not limited to, jurisdictional controls, self-imposed limits, state governmental controls and federal governmental controls, wherein the system provides the logic to determine how, and how much, to transfer from each account of the various interconnected components to satisfy a request for funds while staying within the confines of such rules. In certain embodiments, such a service additionally or alternatively tracks and coalesces transaction history across the accounts of the interconnected components of the system. In these embodiments, all transactions within the system have a “master” transaction record that ties all of the various fund transfers to a single initiating funds transfer regardless of how many accounts were withdrawn to the satisfy the original request.

In certain embodiments, in association with a linking or association of a front money account and a gaming establishment account, the user needs to establish the front money in a front money account maintained by a front money handling system. In certain such embodiments, this establishment of a front money balance includes a user depositing an amount of front money with a gaming establishment interface, such as presenting a check to gaming establishment personnel (which may or may not be deposited by the gaming establishment based on jurisdictional requirements and/or gaming establishment policies), presenting a money order to gaming establishment personnel (which may or may not be deposited by the gaming establishment based on jurisdictional requirements and/or gaming establishment policies) and/or presenting bank account information to gaming establishment personnel in the event the front money accessed exceeds the front money deposited. Following the establishment of the front money balance in the front money account, the system enables the user to utilize any suitable interface to view information about the established front money balance (e.g., an available amount of funds associated with the front money and/or an amount of funds associated with the front money previously accessed) as well as the balance of zero, one or more gaming establishment accounts.

In certain embodiments, in association with opening a front money account, establishing an amount of front money in a front money account and/or linking that front money account with one or more gaming establishment accounts, the system determines zero, one or more front money controls or restrictions. In certain such embodiments, the front money control or restriction pertains to the level of user (and/or gaming establishment personnel) involvement in employing the use of front money. In these embodiments, the system enables the user (and/or gaming establishment personnel) to set the level of involvement to any of: (i) receiving authorization for each transaction that would utilize front money, (ii) receiving authorization for certain transactions that would utilize front money (and automatically employing front money for certain transactions if applicable), or (iii) not receiving any authorization for any transaction that would utilize front money (and automatically employing front money if applicable). In different embodiments, the determination of whether or not to obtain authorization from the user (and/or gaming establishment personnel) to invoke front money is based on one or more factors such as, but not limited to: a status of the user (e.g., a player tracking status of the user as determined via a patron management system), an amount of front money deposited and currently held in a front money account associated with the user, the amount that would be withdrawn from the front money account to provide the front money, the amount that would be withdrawn from the front money account to provide the front money relative to a threshold amount, the amount that would be withdrawn from the front money account to provide the front money relative to a total amount over a period of time, any fees assessed for the amount that would be withdrawn from the front money account to provide the front money, and/or any fees assessed for the amount that would be withdrawn from the front money account to provide the front money relative to a threshold amount.

In certain embodiments, the front money control or restriction additionally or alternatively pertains to employed limitations in employing front money. In these embodiments, such use limitations pertain to the frequency of access to the front money and/or the amounts accessed from the front money. In one such embodiment, the system invokes a limit on the number of times the front money may be employed per period of time. For example, the system limits the user to only two instances of using front money per period of time, such as per week, per month, or per day. In another such embodiment, the system invokes a limit to the amount of front money that may be utilized. In another such embodiment, the system invokes a limit to the amount of front money that may be utilized per a period of time. In different embodiments, the determination of whether or not to employ such limits on invoking front money is based on one or more factors such as, but not limited to: a status of the user (e.g., a player tracking status of the user as determined via a patron management system), a discretion of gaming establishment personnel, an amount of front money deposited and currently held in a front money account associated with the user, a historical spend of the user, and/or historical front money activity of the user.

In certain embodiments, the front money control or restriction additionally or alternatively pertains to use of the front money relative to use of other funding sources. In these embodiments, such use limitations pertain to an order of use of front money relative to the use of alternative funds. For example, the system assigns a use limitation to the front money that requires that, independent of other gaming establishment accounts, the front money funds be exhausted before enabling the user to activate funds from a line of credit maintained by the gaming establishment credit system. In another example, the system assigns a use limitation to the front money that requires the front money funds and funds in other linked gaming establishment accounts each be exhausted before enabling the user to activate funds from a line of credit maintained by the gaming establishment credit system. In another example, the system assigns a use limitation to the front money that requires the funds attempted to be transferred from a gaming establishment account to a front money account first be applied to settle any outstanding amounts owed on any activated lines of credit before such funds are deposited in the front money account.

In certain embodiments, the front money controls are additionally or alternatively associated with the amount of the transaction attempted to be made, such as the amount of front money requested to be transferred to a gaming establishment account. In these embodiments, certain transfers are for an amount above a threshold amount that triggers the use of one or more front money controls while other transfers are for an amount below the threshold amount that do not trigger such front money controls.

In certain embodiments, the front money control or restriction additionally or alternatively pertains to reporting requirements on funds transfers to/from a front money account. In these embodiments, in accordance with jurisdiction requirements, the system employs one or more front money controls that cause an automatic reporting of front money account deposit transactions and/or front money account withdrawal transactions associated with an amount above a threshold amount. In certain embodiments, the front money controls are additionally or alternatively associated with one or more aspects of the transaction attempted to be made, such as the type of destination account the front money is requested to be transferred to, a type of good and/or service of a retail purchase attempted to be made with funds transferred from the front money account to a gaming establishment retail account. In these embodiments, certain types of destination account types and/or retail purchases trigger the use of one or more front money controls while other types of destination account types and/or retail purchases do not trigger such front money controls.

In certain embodiments, the front money controls are additionally or alternatively associated with a location of the transaction attempted to be made. In these embodiments, different locations where the funds transferred from the front money account may be used are associated with different front money controls required to use such funds. In certain embodiments, the front money controls are additionally or alternatively associated with a channel of commerce in which the transaction using such front money funds is attempted to be made. In these embodiments, different channels of commerce where the front money funds may be used are associated with different front money controls required to use such funds. In certain embodiments, the front money controls are additionally or alternatively associated with a time of when the attempted transfer and/or transaction is attempted to be made. In certain embodiments, the front money controls are additionally or alternatively associated with an amount of funds currently maintained in a gaming establishment account associated with a user. In certain embodiments, the front money controls are additionally or alternatively associated with a current rate of consumption of the funds in one or more gaming establishment accounts maintained for the user. In one such embodiment, the rate of consumption is based on an amount of transactions made using funds from a gaming establishment account over a set period of time, such as the current day. In another such embodiment, the rate of consumption is based on an amount of transactions made using funds from a gaming establishment account over a rolling period of time, such as the past twenty-four hours. It should be appreciated that in different embodiments, the system employs a combination of these front money controls to determine whether or not the transfer of funds from a front money account and/or to a front money account is permitted.

In certain embodiments, the system employs the same front money controls for each user whom attempts to complete a transaction, such as a transfer to another gaming establishment account, with funds at least partially obtained from the front money. In certain embodiments, the system employs different front money controls for different users whom attempt to complete a transaction with funds at least partially obtained from the front money. In certain of these embodiments, the system utilizes historical data regarding the user and past gaming establishment transactions in determining one or more aspects of one or more front money controls to associate with that user. In certain of these embodiments, the system utilizes one or more attributes of the user, such as a player tracking account status of the user, in determining one or more aspects of one or more front money controls to associate with that user.

In certain embodiments, the system employs front money that may be accessed to withdraw funds directly from. Such front money has universal applicability for different types of transactions requested by a user. In certain embodiments, the system employs different types of front monies for different types of transactions requested by a user. In these embodiments, the gaming establishment front money handling system maintains multiple distinct and separate front money balances such as a front money balance that may be accessed to withdraw funds directly from a front money balance that may be accessed to transfer funds to another gaming establishment account for use thereof.

In certain embodiments, the system employs the same limits to different front money balances associated with the same user. In certain embodiments, the system employs different limits to different front money balances associated with the same user. In certain embodiments wherein the system imposes one or more fees for accessing the front money, the system employs the same fees to different front monies associated with the same user. In certain embodiments, the system employs different fees to different front monies associated with the same user.

It should be appreciated that certain jurisdictional regulations and/or gaming establishment policies require the user to approve a transaction to access front money funds. In one such embodiment, the user acknowledges the approval of accessing front money funds, when needed, by entering a personal identification number (“PIN”) via a mobile device application, providing a signature and/or presenting a biometric identifier to a mobile device. In another embodiment, the user acknowledges the approval of accessing front money funds, when needed, by entering a PIN, providing a signature and/or presenting a biometric identifier to a gaming establishment device, such as an EGM, a retail point-of-sale terminal or a peripheral device associated with the retail point-of-sale terminal.

In certain embodiments, following an integration of a front money account and one or more gaming establishment accounts and upon an occurrence of a request to transfer an amount of funds from a front money account to a gaming establishment account, a component of the front money handling system (e.g., a front money handling server) operates with a component that maintains the gaming establishment account (e.g., a gaming establishment fund management server) to attempt to complete the fund transfer. In certain such embodiments, the request occurs in association with a deposit of funds in the front money account. In certain such embodiments, the request occurs in association with a transaction attempted to be completed in association with another gaming establishment account. In these embodiments, following the user logging into the front money handling system and/or the gaming establishment fund management system (if needed), the front money handling server operates with the gaming establishment fund management server to determine whether to authorize the transfer of the determined amount of funds from the front money account. Such an authorization is based on the amount of the attempted transfer as well as whether the attempted transfer complies with any applicable front money controls. If the determination is not to authorize the determined amount of funds, such as because the front money account lacks the requested amount of funds and/or if completed, the transfer would violate one or more front money controls, the front money handling server and/or the gaming establishment fund management server denies the transfer and, in certain instances, communicates a denial message which is displayed to the user associated with these accounts.

On the other hand, if the front money handling server and/or the gaming establishment fund management server determines to authorize the determined amount of funds from the front money account, such as because the front money account includes the requested amount of funds and/or if completed, the transfer would comply with one or more front money controls, the front money handling server updates the front money account associated with the user and communicates an authorization to the gaming establishment fund management server. The front money handling server then reduces a balance of the front money account by the transferred amount of funds and the gaming establishment fund management server correspondingly increases a balance of the gaming establishment account by the transferred amount of funds. In certain embodiments, a confirmation of the transfer of the amount of funds and/or the updated balance are displayed to the user associated with these accounts. Such a transferred amount of funds is now available to be used or further transferred on to another gaming establishment account.

It should be appreciated that in certain embodiments, the system protects the balance of the front money account (and the balance of any gaming establishment account) by a cryptographic digital signature. In these embodiments, in addition to or alternative from encrypting the front money balance to protect the balance from malevolent actors, whenever a transfer occurs that modifies the balance of the front money account, the system modifies a second data item as well. This second item is the digital signature on the front money balance that is stored in a database in association with the front money account. In operation, on any programmatic access of the front money balance, the digital signature is verified and any change to the front money balance results in a change, stored in the database, of the digital signature. Such a configuration provides for tamper detection and enables an operator to know that a front money balance has been modified, such as by an outside actor.

In certain embodiments, as indicated above, the deposit of an amount of front money qualifies as a front money transfer transaction that results in a potential transfer of the front money from the front money account to a gaming establishment account. In one such embodiment, the deposit of an amount of front money does not automatically qualify as a front money transfer transaction. In this embodiment, the front money transfer transaction is initiated responsive to the deposit of an amount of front money in the front money account and the receipt of one or more user inputs to initiate and/or authorize the transfer of the front money from the front money account to a gaming establishment account. In another such embodiment, the deposit of an amount of front money automatically qualifies as a front money transfer transaction associated with an automatic initiation of a transfer of the front money from the front money account to a gaming establishment account.

In certain embodiments, as also indicated above, an attempted transaction against another gaming establishment account that lacks the funds to complete the transaction qualifies as a front money transfer transaction that results in a potential transfer of the front money from the front money account to that other gaming establishment account. For example, following one or more inputs received to transfer an amount of funds from a cashless wagering account to an EGM and upon a determination that a cashless wagering account lacks that amount of funds, the cashless wagering system interfaces with the front money handling system to determine if the shortfall of funds in the cashless wagering account can be made up with an amount of front money in the front money account. If so, the front money handling system operates with the cashless wagering system to transfer the deficient amount of funds from the front money account to the cashless wagering account. If not, the front money handling system retains the funds in the front money account without facilitating any transfer. In one such embodiment, an attempted transaction against another gaming establishment account that lacks the funds to complete the transaction does not automatically qualify as a front money transfer transaction. In this embodiment, the front money transfer transaction is initiated responsive to an attempted transaction against another gaming establishment account that lacks the funds to complete the transaction and the receipt of one or more user inputs to initiate and/or authorize the transfer of the front money from the front money account to a gaming establishment account. In another such embodiment, an attempted transaction against another gaming establishment account that lacks the funds to complete the transaction automatically qualifies as a front money transfer transaction associated with an automatic initiation of a transfer of the front money from the front money account to the other gaming establishment account.

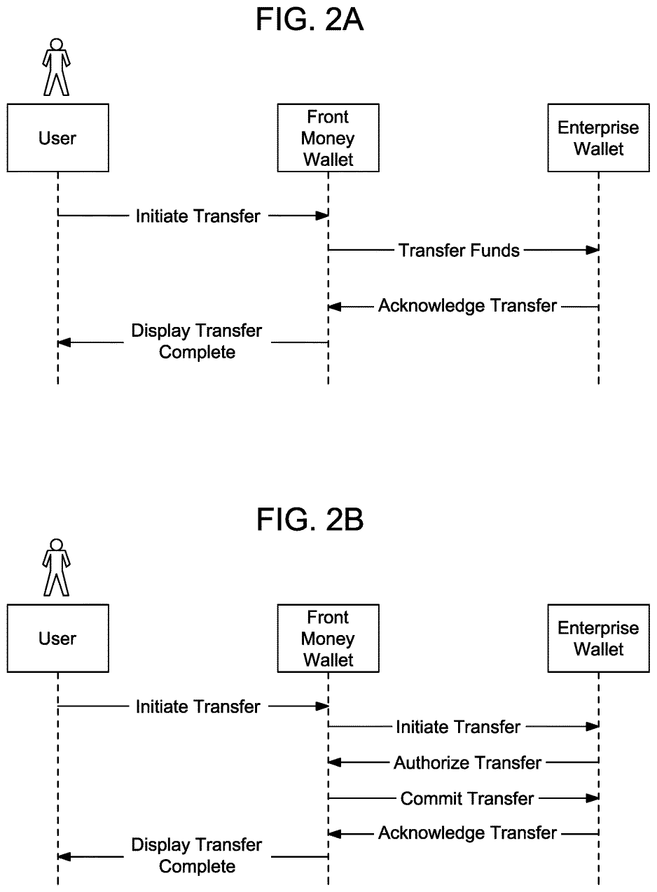

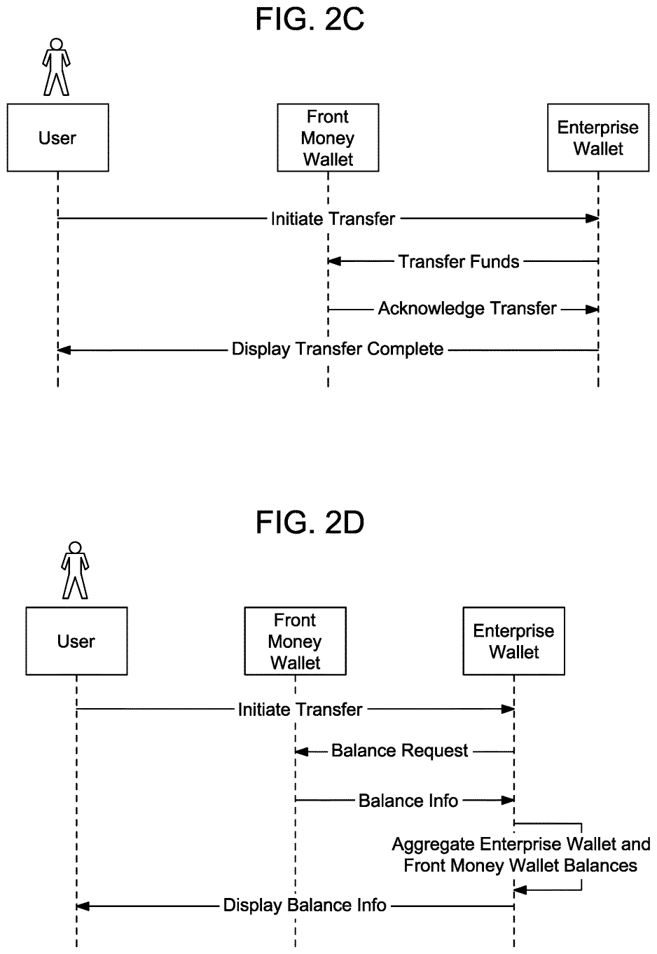

In certain embodiments, the initiation of the transfer of front money funds from a front money account to a gaming establishment account (and/or alternatively from a gaming establishment account to a front money account) originates from the front money handling system. In these embodiments, the front money wallet is a one-way wallet in which the transfer of funds to (and/or from) that front money wallet is initiated by the front money handling system (and not by any other component of the gaming establishment fund management system). For example, as seen in FIG. 2A (which shows a single phased fund transfer transaction using two messages) and FIG. 2B (which shows a two phased fund transfer transaction that pairs two request responses such that the transfer is initiated, authorized, committed and acknowledged as complete), following a deposit of an amount of front money funds in a front money account and one or more user inputs to initiate a transfer of funds, the front money handling system that maintains a front money account (i.e., the displayed front money wallet) operates with a component of a cashless wagering system that maintains a cashless wagering account (i.e., the displayed enterprise wallet) to attempt to transfer part or all of the amount of front money funds to the cashless wagering account. In another example, upon a user attempting to withdraw money (or otherwise close out) a front money account at the end of the user's gaming establishment visit, the front money handling system determines an amount of front money transferred from the front money account to a gaming establishment account and the front money handling system then operates with a component of a gaming establishment fund management system that maintains the gaming establishment account to attempt to transfer part or all of the determined amount of front money funds from the gaming establishment account to the front money account.

In certain embodiments, the initiation of the transfer of front money funds from a front money account to a gaming establishment account (and/or alternatively from a gaming establishment account to a front money account) originates from either the front money handling system or a component that maintains the gaming establishment account. In these embodiments, the front money wallet is a two-way wallet in which the transfer of funds to (and/or from) that front money wallet is initiated by the front money handling system and/or any other component of the gaming establishment fund management system. For example, as seen in FIG. 2C, upon a user interfacing with a component of a cashless wagering system that maintains a cashless wagering account (i.e., the displayed enterprise wallet) to attempt to transfer money from the cashless wagering account to a component of the front money handling system that maintains the front money account (i.e., the displayed front money wallet), such as to close out a front money account at the end of the user's gaming establishment visit, these components operate together to attempt to transfer part or all of the determined amount of front money funds from the cashless wagering account to the front money account.

In certain embodiments, in association with the linkage of a two-way front money account and one or more gaming establishment accounts, the system enables one or more components which maintain such gaming establishment accounts to make balance requests of the front money account. For example, as seen in FIG. 2D, in association with an initiated transfer of funds from a cashless wagering account, a component of a cashless wagering system that maintains the cashless wagering account (i.e., the displayed enterprise wallet) obtains front money account balance information from the front money handling system that maintains the front money account (i.e., the displayed front money wallet) and utilizes such obtained front money balance information to display separate balances (and/or aggregated balance) of the front money account and the cashless wagering account. In certain embodiments, in association with the linkage of a two-way front money account and one or more gaming establishment accounts, the system additionally or alternatively enables the front money handling system to make balances requests of one or more gaming establishment accounts. In these embodiments, in addition to enabling the front money handling system to interact with one or more components of a gaming establishment fund management system to cause transfers of funds between a front money account and one or more gaming establishment accounts (and similarly enabling one or more components of a gaming establishment fund management system to interface with the front money handling system to cause transfers of funds between one or more gaming establishment accounts and a front money account), these components interact, via a series of application programming interfaces, to initiate balance requests of the different accounts.

It should be appreciated that while generally described as transferring funds between a front money account and a cashless wagering account, the system of the present disclosure is additionally or alternatively operable to transfer funds between a front money account and a gaming establishment retail account (or other gaming establishment account other than a cashless wagering account). That is, in addition to or alternative from using front money associated with a user to fund a gaming transaction via a transfer to a cashless wagering account associated with the user and then to a gaming device, the system of the present disclosure uses front money associated with a user to fund a non-gaming transaction, such as a retail transaction, via a transfer to another gaming establishment account associated with the user and then to a retail point-of-sale terminal.

In certain such embodiments, to facilitate the transfer of funds from a gaming establishment retail account to an account associated with a retailer to purchase goods and/or services from the retailer (with or without the aid of front money provided by a user and held in a front money account), the user presents a retail wallet identity (e.g., a physical card associated with the gaming establishment retail account, a mobile device running a mobile device application associated with the gaming establishment retail account, or a mobile device that presents an identity associated with the user or the user's gaming establishment retail account) to potentially access the funds in the gaming establishment retail account for the purchase transaction. In these embodiments, upon the presentation of the retail wallet identity at an applicable point-of-sale terminal of a retail point-of-sale system within or otherwise associated with the gaming establishment for the purchase of goods and/or services, the system determines whether or not to complete the attempted retail purchase. For example, when a purchase of goods and/or services is attempted to be made with funds from a gaming establishment retail account using a mobile device application at a point-of-sale terminal, the mobile device application prompts the user to cause the mobile device to engage the point-of-sale terminal, such as prompting the user to tap the mobile device to a designated portion of the point-of-sale terminal (or otherwise moving the mobile device to within a designated distance of a designated location of the point-of-sale terminal). Such engagement initiates a pairing or linkage between the mobile device and the point-of-sale terminal (or a component of a gaming establishment fund management system located inside the point-of-sale terminal (i.e., a component of the point-of-sale terminal)), wherein the pairing or linkage between the mobile device and the point-of-sale terminal occurs via one or more applications being run or executed on the mobile device. In this example, after such engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with the retail wallet identity to the point-of-sale terminal to facilitate the potential purchase of goods and/or services. In various embodiments, in addition to or alternative from attempting to make purchases of goods and/or services with funds in a gaming establishment retail account at a point-of-sale terminal, the system of the present disclosure enables a user to attempt to make purchases of goods and/or services with funds in a gaming establishment retail account via any suitable interface, such as a user interface of an EGM, a user interface of a gaming table component associated with a gaming table, a kiosk, a mobile device application being executed by a mobile device, a service window displayed by a gaming device (e.g., a remote host controlled service window displayed by an EGM), and/or a gaming establishment interface (e.g., a casino desk).

In various embodiments, upon receiving data or information regarding the retail wallet identity, the retail point-of-sale system interfaces with, such as via one or more application programming interfaces, the gaming establishment fund management system to determine if the gaming establishment retail account has adequate funds for the intended purchase. Upon receiving the request of the determined amount of funds and logging the user into a gaming establishment account associated with the user (if necessary), a component of the gaming establishment retail wallet system (and/or another component of the gaming establishment fund management system) determines whether to authorize the transfer of the determined amount of funds. In these embodiments, the component of the gaming establishment retail wallet system (e.g., one or more servers of the retail wallet system) and/or the component of the gaming establishment fund management system (e.g., one or more servers of the gaming establishment fund management system) determines whether the gaming establishment retail account includes an amount of funds at least equal to the requested amount of funds to complete the transaction.

If the gaming establishment retail wallet system (and/or another component of the gaming establishment fund management system) confirms the presence of adequate funds in the gaming establishment retail account, the retail point-of-sale system (and/or another component of the gaming establishment fund management system) authorizes the sale of the goods and/or services. The gaming establishment retail wallet system (and/or another component of the gaming establishment fund management system) then proceeds to transfer an amount of funds to cover the purchased goods and/or services from the gaming establishment retail account to an account associated with the retail point-of-sale system (and/or the retail establishment) to complete the purchase of the goods and/or services. In these embodiments, if the component of the gaming establishment retail wallet system (and/or another component of the gaming establishment fund management system) determines to authorize the determined amount of funds because the amount of funds in the gaming establishment retail account at least equals the requested amount of funds to complete the purchase transaction, the component of the gaming establishment retail wallet system (and/or another component of the gaming establishment fund management system) updates the gaming establishment retail account associated with the user (to reflect the transfer out of the requested amount of funds) and communicates an authorization to the point-of-sale terminal. Such a transfer of funds to complete the purchase of the goods and/or services is associated with a transaction identification which one or more components of the system store for reporting purposes.

It should be appreciated that in certain embodiments, upon the gaming establishment fund management system determining that the entire amount of the requested amount of funds to complete the purchase transaction are available from the gaming establishment retail account maintained by the gaming establishment fund management system, the requested transaction is completed without accessing any front money from any front money account. As such, certain embodiments of transferring funds from a gaming establishment account to complete a retail purchase involve the user requesting, via an interface, an amount of funds to be transferred to complete the purchase, and if the requested amount of funds can be covered by the funds currently associated with a gaming establishment retail account, facilitate the transfer of funds from the gaming establishment retail account without accessing any front money funds from any front money account.

On the other hand, if the gaming establishment retail wallet system (and/or another component of the gaming establishment fund management system) indicates that the gaming establishment retail account lacks adequate funds for the attempted purchase, the gaming establishment retail wallet system (and/or another component of the gaming establishment fund management system) determines whether to potentially employ front money held in a front money account to potentially facilitate the completion of the purchase transaction. In these embodiments, the determination of whether to complete the attempted purchase transaction when the gaming establishment retail account lacks the funds to otherwise complete the purchase transaction is based on whether the gaming establishment retail account is associated with the front money account, an amount of front money available in the front money account, a level of access provided to the front money handling system and whether the attempted transaction complies with any front money controls in place.

In these embodiments, if a determination occurs that the gaming establishment retail account is not associated with any front money account, the gaming establishment retail wallet system (and/or another component of the gaming establishment fund management system) denies the purchase transaction because the gaming establishment retail account lacks adequate funds. In other words, if the gaming establishment retail account is not linked to a front money account or otherwise access to the front money account is prohibited, the retail point-of-sale system (and/or the gaming establishment fund management system) denies the sale transaction of the goods and/or services using the gaming establishment retail account. In certain embodiments, the system utilizes the denial of the attempted purchase to offer the user the opportunity to link a front money account to the gaming establishment retail account (or other gaming establishment accounts).

In certain embodiments, even if the gaming establishment retail account is associated with a front money account funded by front money provided by the user, if a determination occurs that the employment of the front money violates any applicable front money controls, the gaming establishment retail wallet system (and/or another component of the gaming establishment fund management system) denies the purchase transaction. On the other hand, if a determination occurs that the requested transaction complies with any applicable front money controls, the gaming establishment retail wallet system (and/or another component of the gaming establishment fund management system) interfaces with, such as via one or more application programming interfaces, a component of a gaming establishment front money handling system (e.g., one or more servers of a gaming establishment front money handling system) to determine if the difference between the amount of funds to complete the transaction and any funds in the gaming establishment retail account can be withdrawn from front money associated with the user. That is, following a determination that a shortfall exists between the amount of funds needed to complete the purchase and the amount of funds available to be transferred from the gaming establishment retail account, a component of the gaming establishment front money handling system (and/or a component of the system that maintains the gaming establishment retail account associated with the user) determines whether or not to authorize that the shortfall be covered by an amount of funds accessed from the front money provided by the user. In other words, if the system determines that the balance of the gaming establishment retail account associated with the user lacks sufficient funds to cover the attempted purchase, the system queries the gaming establishment front money handling system to determine if the user has a sufficient front money balance to, when combined with funds available from the gaming establishment retail account, at least equal the amount of funds associated with the attempted purchase.

In certain such embodiments, following receipt, from the component of the gaming establishment fund management system, of data associated with an amount of funds to be accessed from the front money balance (that, when combined with any contribution of any funds from any gaming establishment retail account, form the amount of funds to be transferred as part of the purchase transaction), the gaming establishment front money handling system logs the user into the gaming establishment front money handling system (if necessary) and requests access to the amount of funds from the front money of the user. The gaming establishment front money handling system then proceeds with determining whether to complete the transfer of the amount of funds to be accessed from the front money of the user. In certain embodiments, to complete a transfer of the amount of funds associated with the front money of the user to account for any shortfall in the funds otherwise in the gaming establishment retail account, the gaming establishment front money handling system determines whether to authorize the access of the amount of funds from the front money associated with the user. If the component of the front money handling system determines not to authorize the transfer of the amount of funds to be accessed from the front money of the user, the system communicates data to the component of the gaming establishment fund management system denying the request of funds accessed from the front money of the user. For example, if the gaming establishment front money handling system determines that an amount of funds available from the front money of the user is less than the requested amount of funds needed to complete the purchase, the gaming establishment front money handling system denies the access of funds from the front money of the user. Without access to the funds from the front money of the user and aware that the amount of funds in the gaming establishment retail account are insufficient to cover the attempted purchase, the gaming establishment fund management system communicates a denial of the attempted purchase to the retail point-of-sale terminal. In these embodiments, if the component of the front money handling system determines that the amount of funds available from the front money are inadequate (or otherwise in violation of one or more front money controls), when combined with any funds from the gaming establishment retail account, to cover the amount of the purchase, the system does not proceed with the purchase. In certain embodiments, the gaming establishment fund management system and/or the gaming establishment retail system notifies the user, via one or more of a message displayed on a displayed message at a gaming establishment device, an email, a SMS or text message, and/or a notification displayed by a mobile device application of the reasons for denying the transaction.

On the other hand, if the component of the gaming establishment front money handling system determines to authorize the transfer the amount of funds from the front money account of the user, the component of the gaming establishment front money handling system operates with the component of the gaming establishment fund management system to access an amount of funds from the front money account (and, in certain instances, issue a marker associated with the funds accessed from the front money provided by the user) and then transfer the accessed amount of funds to facilitate the completion of the transaction. In these embodiments, if the gaming establishment front money handling system determines to authorize the access to an amount of funds from the front money provided by the user, the gaming establishment front money handling system updates the amount available in the front money account to reflect the amount withdrawn from the front money account, issues, in certain embodiments, a marker for the amount withdrawn from the front money account, and communicates an authorization of the amount of funds to the gaming establishment fund management system. Upon receiving the authorization, the gaming establishment fund management system updates a balance of a gaming establishment retail account by the amount of funds accessed from the front money provided by the user.

Following the transfer of funds accessed from the front money provided by the user to the gaming establishment retail account and aware that the amount of funds now in the gaming establishment retail account at least equals the requested amount of funds to complete the purchase transaction, the component of the gaming establishment fund management system operates with the component of the gaming establishment retail system to complete the transaction. That is, upon the gaming establishment retail wallet system (and/or another component of the gaming establishment fund management system) confirming the presence of adequate funds in the gaming establishment retail account, the gaming establishment retail wallet system (and/or the gaming establishment fund management system) authorizes the sale of the goods and/or services. The gaming establishment retail wallet system (and/or another component of the gaming establishment fund management system) then proceeds to transfer an amount of funds to cover the purchased goods and/or services from the gaming establishment retail account to an account associated with the retail point-of-sale system (and/or the retail establishment) to complete the purchase of the goods and/or services. In these embodiments, if the component of the gaming establishment retail wallet system (and/or another component of the gaming establishment fund management system) determines to authorize the determined amount of funds because the amount of funds currently in the gaming establishment retail account (which has been supplemented with user provided front money) at least equals the requested amount of funds to complete the purchase transaction, the component of the gaming establishment retail wallet system (and/or another component of the gaming establishment fund management system) updates the gaming establishment retail account associated with the user (to reflect the transfer out of the requested amount of funds) and communicates an authorization to the point-of-sale terminal. Such a transfer of funds to complete the purchase of the goods and/or services is associated with a transaction identification which one or more components of the system store for reporting purposes. In certain embodiments, the gaming establishment fund management system and/or the gaming establishment retail system notifies the user, via one or more of a message displayed on a displayed message at a gaming establishment device, an email, a SMS or text message, and/or a notification displayed by a mobile device application of the completion of the transaction, the current balances of one or more accounts (including one or more front money accounts).

Accordingly, in certain embodiments, wherein the gaming establishment device is a retail point-of-sale terminal, following the transfer of the requested amount of funds to a gaming establishment retail account (sourced, at least in part, by accessing front money from a front money account associated with the gaming establishment retail account), the transferred amounts of funds are available to purchase goods and/or services. In certain other embodiments wherein the gaming establishment device is an EGM, following the transfer of the requested amount of funds to a cashless wagering account (sourced, at least in part, by accessing front money from a front money account associated with the cashless wagering account), the transferred amounts of funds are available for wagering by the user at the EGM. In certain other embodiments wherein the gaming establishment device is a sports betting kiosk, following the transfer of the requested amount of funds to a sports betting cashless wagering account (sourced, at least in part, by accessing front money from a front money account associated with the sports betting cashless wagering account), the transferred amounts of funds are available for wagering by the user on sporting events at the sports betting kiosk. In certain other embodiments, wherein the gaming establishment device is a gaming table component, following the transfer of the requested amount of funds (sourced, at least in part, by accessing front money from a front money account associated with the gaming establishment account), gaming establishment personnel issue the user at the gaming table an amount of gaming chips (corresponding to the amount of transferred funds) for wagering on one or more plays of one or more games at the gaming table. In certain such embodiments, the gaming table component causes a display device to display instructions to gaming establishment personnel to issue the user an amount of gaming chips corresponding to the amount of transferred funds and/or causes a printer to generate a receipt with instructions to gaming establishment personnel to issue the user an amount of gaming chips corresponding to the amount of transferred funds.

In certain embodiments, the coordination of transferring funds to a gaming establishment device from one or more gaming establishment accounts (including, in certain instances, a front money account) is executed by a component of the gaming establishment fund management system, such as a component of the gaming establishment front money handling system. In certain other embodiments, the coordination of transferring funds to a gaming establishment device from one or more gaming establishment accounts (including, in certain instances, a front money account) is executed by the gaming establishment device. In certain such embodiments, the gaming establishment device queries the component of the gaming establishment fund management system, such as the component of the gaming establishment front money handling system if a shortfall exists between the amount of funds requested and the amount of funds available from the gaming establishment account maintained by the gaming establishment fund management system and/or the amount of funds available from the front money associated with the user.

In various embodiments, prior to using funds in a gaming establishment account, such as transferring funds in a cashless wagering account to a gaming device for wagering and/or using funds in a gaming establishment retail account to purchase goods and/or services (with or without the aid of front money provided by the user), the system enables the gaming establishment account to be funded from one or more sources. In certain embodiments, the system enables the gaming establishment account to be directly funded from one or more of such sources. In certain embodiments, the system enables the gaming establishment account to be indirectly funded from one or more of such sources, such as by an amount of funds from such sources first being transferred to another gaming establishment account and then such an amount of funds being transferred from the other gaming establishment account to the gaming establishment account.

In certain embodiments, the gaming establishment account is associated with one or more external accounts, such as one or more credit card accounts, one or more debit card accounts and/or one or more third-party maintained accounts (e.g., one or more PayPal® accounts or Venmo® accounts). In certain embodiments, the gaming establishment account is associated with a gaming establishment or a group of gaming establishments, wherein the user establishes a gaming establishment account by a deposit of funds (such as at a kiosk) to be subsequently utilized in association with the mobile device application. In other embodiments, the gaming establishment account is funded via a mobile device electronic fund transfer, such using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account. In certain embodiments, the system enables funds to be deposited in a gaming establishment account via activating a line of credit associated with the user.

In certain embodiments, the system enables funds to be deposited in a gaming establishment account, via a gaming device, such as an EGM and/or via a non-gaming device, such as a kiosk. In certain embodiments, the system enables a user that has an amount of cash to utilize a gaming device and/or a non-gaming device to convert the cash to an amount deposited into a gaming establishment account (which may be subsequently transferred utilizing a mobile device application). In other embodiments, the system enables funds to be deposited in a gaming establishment account via a gaming device and/or a non-gaming device that accepts printed ticket vouchers. In these embodiments, the system enables a user that has one or more printed ticket vouchers to utilize a gaming device and/or a non-gaming device to convert the printed ticket voucher to an amount deposited into a gaming establishment account (which may be subsequently transferred utilizing a mobile device application).

In certain embodiments, the system enables funds to be deposited in a gaming establishment account via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a gaming establishment account (which may be subsequently transferred utilizing a mobile device application). In other embodiments, the system enables funds to be deposited in a gaming establishment account via a gaming establishment interface that accepts printed ticket vouchers. In these embodiments, the system enables a user that has one or more printed ticket vouchers to utilize a gaming establishment interface to convert the printed ticket voucher to an amount deposited into a gaming establishment account (which may be subsequently transferred utilizing a mobile device application).

In certain embodiments, the gaming establishment account is associated with funds associated with one or more virtual ticket vouchers. In certain embodiments, the system enables a user associated with an amount of virtual ticket vouchers to utilize a gaming device (e.g., an EGM, or a component of an EGM), a non-gaming device (e.g., a kiosk), a mobile device running a mobile device application, and/or a gaming establishment interface to convert the virtual ticket vouchers to an amount deposited into a gaming establishment account.

It should be appreciated that the electronic fund data transfers of the present disclosure may occur in addition to or as an alternative from cash-based fund transfers and/or ticket voucher-based fund transfers. In one such embodiment, an amount of funds transferred to a gaming establishment device (e.g., an EGM or a retail point-of-sale terminal) is funded via any of an electronic fund transfer, a cash-based fund transfer or a ticket voucher-based fund transfer. In another embodiment, an amount of funds transferred from a gaming establishment device (e.g., an EGM or a gaming table component) is cashed out via any of an electronic fund transfer, a cash-based fund transfer or a ticket voucher-based fund transfer. In another embodiment, an amount of funds transferred to a gaming establishment device (e.g., an EGM or a retail point-of-sale terminal) is funded via an electronic fund transfer or a cash-based fund transfer (but is not funded via any ticket voucher-based fund transfer). In another embodiment, an amount of funds transferred from a gaming establishment device (e.g., an EGM or a gaming table component) is cashed out via an electronic fund transfer or a cash-based fund transfer (but is not cashed out via any ticket voucher-based fund transfer). In another embodiment, an amount of funds transferred to a gaming establishment device (e.g., an EGM or a retail point-of-sale terminal) is funded via an electronic fund transfer or a ticket voucher-based fund transfer (but is not funded via any cash-based fund transfer). In another embodiment, an amount of funds transferred from a gaming establishment device (e.g., an EGM or a gaming table component) is cashed out via an electronic fund transfer or a ticket voucher-based fund transfer (but is not cashed out via any cash-based fund transfer). In another embodiment, an amount of funds transferred to a gaming establishment device (e.g., an EGM or a retail point-of-sale terminal) is funded via an electronic fund transfer (but is not funded via a cash-based fund transfer nor a ticket voucher-based fund transfer). In another embodiment, an amount of funds transferred from a gaming establishment device (e.g., an EGM or a gaming table component) is cashed out via an electronic fund transfer (but is not cashed out via a cash-based fund transfer nor a ticket voucher-based fund transfer).

It should be further appreciated that any functionality or process of the present disclosure may be implemented via one or more servers (associated with or independent of any component of any system disclosed herein), one or more gaming establishment devices (e.g., a gaming device such as an EGM or a non-gaming device such as a point-of-sale terminal), one or more components of a gaming establishment device (such as a component of a gaming establishment management system supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device or a component associated with a gaming establishment device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming establishment devices, one or more components of a gaming establishment device, or one or more gaming establishment components, (iii) while certain functions, features or processes are described herein as being performed by one or more servers, such functions, features or processes may alternatively be performed by one or more gaming establishment devices, one or more components of a gaming establishment device, one or more mobile device applications, or one or more gaming establishment components, and (iv) while certain functions, features or processes are described herein as being performed by one or more gaming establishment components, such functions, features or processes may alternatively be performed by one or more gaming establishment devices, one or more components of a gaming establishment device, or one or more servers.

In certain embodiments, the above-described embodiments of the present disclosure may be implemented in accordance with or in conjunction with zero, one or more components of a gaming establishment fund management system (e.g., a cashless wagering system or a gaming establishment retail system); zero, one or more components of a front money handling system; zero, one or more components of a gaming establishment patron management system; zero, one or more components of a retail point-of-sale system; and/or zero, one or more gaming establishment devices. In these embodiments, such components of the gaming establishment fund management system, the front money handling system, the gaming establishment patron management system, the retail point-of-sale system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the front money handling system, the component of the retail point-of-sale system and/or the gaming establishment device; (3) accessing memory to configure or reconfigure parameters in the memory according to indicia read from the component of the gaming establishment fund management system, the component of the front money handling system, the component of the retail point-of-sale system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the front money handling system, the component of the retail point-of-sale system and/or the gaming establishment device, while in other embodiments, at least one component of the controller resides outside of the housing of the component of the gaming establishment fund management system, the component of the front money handling system, the component of the retail point-of-sale system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the front money handling system, the component of the retail point-of-sale system and/or the gaming establishment device disclosed herein. In certain embodiments, the at least one memory device resides within the housing of the component of the gaming establishment fund management system, the component of the front money handling system, the component of the retail point-of-sale system and/or the gaming establishment device, while in other embodiments at least one component of the at least one memory device resides outside of the housing of the component of the gaming establishment fund management system, the component of the front money handling system, the component of the retail point-of-sale system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the front money handling system, the component of the retail point-of-sale system and/or the gaming establishment device; (2) associations between configuration indicia read from the component of the gaming establishment fund management system, the component of the front money handling system, the component of the retail point-of-sale system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the front money handling system, the component of the retail point-of-sale system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the front money handling system, the component of the retail point-of-sale system and/or the gaming establishment device to control the component of the gaming establishment fund management system, the component of the front money handling system, the component of the retail point-of-sale system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the front money handling system, the component of the retail point-of-sale system and/or the gaming establishment device through any suitable data network described above (such as an Internet or intranet).

The at least one memory device also stores a plurality of device drivers. Examples of different types of device drivers include device drivers for the component of the gaming establishment fund management system, the component of the front money handling system, the component of the retail point-of-sale system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the front money handling system, the component of the retail point-of-sale system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the front money handling system, the component of the retail point-of-sale system and/or the gaming establishment device loads the new device driver from the at least one memory device to enable communication with the new device. For instance, one type of card reader in the component of the gaming establishment fund management system, the component of the front money handling system, the component of the retail point-of-sale system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the front money handling system, the component of the retail point-of-sale system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the front money handling system, the component of the retail point-of-sale system and/or the gaming establishment device. In various embodiments, the display devices serve as digital glass configured to aspects of the gaming establishment in which the component of the gaming establishment fund management system, the component of the front money handling system, the component of the retail point-of-sale system and/or the gaming establishment device is located. In various embodiments, the component of the gaming establishment fund management system, the component of the front money handling system, the component of the retail point-of-sale system and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the front money handling system, the component of the retail point-of-sale system and/or the gaming establishment device receives an actuation, the component of the gaming establishment fund management system, the component of the front money handling system, the component of the retail point-of-sale system and/or the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the front money handling system, the component of the retail point-of-sale system and/or the gaming establishment device provides dynamic sounds coupled with attractive multimedia images displayed on one or more of the display devices to provide an audio-visual representation or to otherwise display full-motion video with sound to attract users to the component of the gaming establishment fund management system, the component of the front money handling system, the component of the retail point-of-sale system and/or the gaming establishment device. In certain embodiments, the component of the gaming establishment fund management system, the component of the front money handling system, the component of the retail point-of-sale system and/or the gaming establishment device displays a sequence of audio and/or visual attraction messages during idle periods to attract potential users to the component of the gaming establishment fund management system, the component of the front money handling system, the component of the retail point-of-sale system and/or the gaming establishment device. The videos may be customized to provide any appropriate information.

The at least one input device may include any suitable device that enables an input signal to be produced and received by the at least one processor of the component of the gaming establishment fund management system, the component of the front money handling system, the component of the retail point-of-sale system and/or the gaming establishment device. In one embodiment, the at least one input device includes a payment device configured to communicate with the at least one processor of the component of the gaming establishment fund management system, the component of the front money handling system, the component of the retail point-of-sale system and/or the gaming establishment device to fund the component of the gaming establishment fund management system, the component of the front money handling system, the component of the retail point-of-sale system and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the front money handling system, the component of the retail point-of-sale system and/or the gaming establishment device to be funded via an electronic funds transfer, such as a transfer of funds from a bank account. In another embodiment, the component of the gaming establishment fund management system, the component of the front money handling system, the component of the retail point-of-sale system and/or the gaming establishment device includes a payment device configured to communicate with a mobile device of a user, such as a mobile phone, a radio frequency identification tag, or any other suitable wired or wireless device, to retrieve relevant information associated with that user to fund the component of the gaming establishment fund management system, the component of the front money handling system, the component of the retail point-of-sale system and/or the gaming establishment device. When the component of the gaming establishment fund management system, the component of the front money handling system, the component of the retail point-of-sale system and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the front money handling system, the component of the retail point-of-sale system and/or the gaming establishment device operator to, when actuated, cause the component of the gaming establishment fund management system, the component of the front money handling system, the component of the retail point-of-sale system and/or the gaming establishment device to perform particular functions. For instance, such buttons may be hard keys, programmable soft keys, or icons icon displayed on a display device of the component of the gaming establishment fund management system, the component of the front money handling system, the component of the retail point-of-sale system and/or the gaming establishment device that are actuatable via a touch screen of the component of the gaming establishment fund management system, the component of the front money handling system, the component of the retail point-of-sale system and/or the gaming establishment device or via use of a suitable input device of the component of the gaming establishment fund management system, the component of the front money handling system, the component of the retail point-of-sale system and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the front money handling system, the component of the retail point-of-sale system and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the front money handling system, the component of the retail point-of-sale system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the front money handling system, the component of the retail point-of-sale system and/or the gaming establishment device, such as one or more rechargeable power sources (e.g., rechargeable batteries) located at the component of the gaming establishment fund management system, the component of the front money handling system, the component of the retail point-of-sale system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the front money handling system, the component of the retail point-of-sale system and/or the gaming establishment device; detecting the presence and/or identity of various persons (e.g., users, casino employees, etc.), devices (e.g., user input devices), and/or systems within a predetermined proximity to the component of the gaming establishment fund management system, the component of the front money handling system, the component of the retail point-of-sale system and/or the gaming establishment device.

The at least one data preservation component is configured to detect or sense one or more events and/or conditions that, for example, may result in damage to the component of the gaming establishment fund management system, the component of the front money handling system, the component of the retail point-of-sale system and/or the gaming establishment device and/or that may result in loss of information associated with the component of the gaming establishment fund management system, the component of the front money handling system, the component of the retail point-of-sale system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment fund management system, the component of the front money handling system, the component of the retail point-of-sale system and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the front money handling system, the component of the retail point-of-sale system and/or the gaming establishment device. For example, in one implementation, the at least one geolocation module is configured to receive GPS signal information for use in determining the position or location of the component of the gaming establishment fund management system, the component of the front money handling system, the component of the retail point-of-sale system and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the front money handling system, the component of the retail point-of-sale system and/or the gaming establishment device.

The at least one user identification module is configured to determine the identity of the current user or current owner of the component of the gaming establishment fund management system, the component of the front money handling system, the component of the retail point-of-sale system and/or the gaming establishment device. For example, in one embodiment, the current user is required to perform a login process at the component of the gaming establishment fund management system, the component of the front money handling system, the component of the retail point-of-sale system and/or the gaming establishment device in order to access one or more features. Alternatively, the component of the gaming establishment fund management system, the component of the front money handling system, the component of the retail point-of-sale system and/or the gaming establishment device is configured to automatically determine the identity of the current user based on one or more external signals, such as an RFID tag or badge worn by the current user and that provides a wireless signal to the component of the gaming establishment fund management system, the component of the front money handling system, the component of the retail point-of-sale system and/or the gaming establishment device that is used to determine the identity of the current user. In at least one embodiment, various security features are incorporated into the component of the gaming establishment fund management system, the component of the front money handling system, the component of the retail point-of-sale system and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the front money handling system, the component of the retail point-of-sale system and/or the gaming establishment device.

In various embodiments, the component of the gaming establishment fund management system, the component of the front money handling system, the component of the retail point-of-sale system and/or the gaming establishment device includes a plurality of communication ports configured to enable the at least one processor of the component of the gaming establishment fund management system, the component of the front money handling system, the component of the retail point-of-sale system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the front money handling system, the component of the retail point-of-sale system and/or the gaming establishment device has a support structure, housing, or cabinet that provides support for a plurality of the input devices and the output devices of the component of the gaming establishment fund management system, the component of the front money handling system, the component of the retail point-of-sale system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A gaming establishment fund management system comprising:
a processor; and
a memory device that stores a plurality of instructions that, when executed by the processor following an occurrence of a request to complete, in association with a first amount of funds, a gaming establishment cashless transaction independent of any computing components on any banking network, independent of any physical currency being manually exchanged and without accessing any source of funds remote from the gaming establishment fund management system and responsive to a gaming establishment account being associated with a second amount of funds that is less than the first amount of funds, cause the processor to:
exchange information with a server of an independently operating gaming establishment front money handling system to determine if the gaming establishment account is associated with a front money account maintained by the gaming establishment front money handling system,
responsive to the gaming establishment account being associated with the front money account, authorize a completion of the gaming establishment cashless transaction, wherein a difference between the first amount of funds and the second amount of funds is accessed from an amount of front money of the associated front money account, and
responsive to the gaming establishment account not being associated with the front money account and the gaming establishment account being associated with the second amount of funds that is less than the first amount of funds, deny a completion of the gaming establishment cashless transaction.

2. The gaming establishment fund management system of claim 1, wherein responsive to the gaming establishment account being associated with the front money account, the amount of front money of the associated front money account comprises at least the difference between the first amount of funds and the second amount of funds and the gaming establishment account is associated with the second amount of funds, the authorization to complete the gaming establishment cashless transaction automatically occurs.

3. The gaming establishment fund management system of claim 1, wherein the request to complete the gaming establishment cashless transaction is initiated independent of the front money account.

4. The gaming establishment fund management system of claim 1, wherein the authorization to complete the gaming establishment cashless transaction occurs following a receipt of an input, via an input device, to approve an access of the amount of front money.

5. The gaming establishment fund management system of claim 1, wherein the request to complete the gaming establishment cashless transaction is initiated in association with the front money account.

6. The gaming establishment fund management system of claim 1, wherein the gaming establishment account comprises a cashless wagering account and the gaming establishment cashless transaction comprises a transfer of the first amount of funds to a balance of a gaming device.

7. The gaming establishment fund management system of claim 6, wherein the gaming device comprises one of an electronic gaming machine and a gaming table component associated with a gaming table.

8. The gaming establishment fund management system of claim 1, wherein the gaming establishment account comprises a gaming establishment retail account, and the gaming establishment cashless transaction comprises a transfer of the first amount of funds to an account associated with a point-of-sale retail terminal.

9. A gaming establishment front money handling system comprising:
a processor; and
a memory device that stores a plurality of instructions that, when executed by the processor, cause the processor to:
maintain a front money account, and
responsive to a deposit of an amount of front money in the front money account:
exchange information with a server of an independently operating gaming establishment fund management system determine if the front money account is associated with any gaming establishment accounts maintained by the gaming establishment fund management system, and
responsive to the determination being that the front money account is associated with a gaming establishment account, authorize a transfer of the amount of front money to the gaming establishment account.

10. The gaming establishment front money handling system of claim 9, wherein the transfer is automatically initiated, independent of any inputs received via an input device to approve the transfer, by the processor responsive to the determination that the front money account is associated with the gaming establishment account.

11. The gaming establishment front money handling system of claim 9, wherein the transfer is initiated by the server of the gaming establishment fund management system.

12. The gaming establishment front money handling system of claim 9, wherein the gaming establishment account comprises one of a cashless wagering account and a gaming establishment retail account.

13. A method of operating a gaming establishment fund management system, the method comprising:
following an occurrence of a request to complete, in association with a first amount of funds, a gaming establishment cashless transaction independent of any computing components on any banking network, independent of any physical currency being manually exchanged and without accessing any source of funds remote from the gaming establishment fund management system and responsive to a gaming establishment account being associated with a second amount of funds that is less than the first amount of funds:
exchanging, by a processor, information with a server of an independently operating gaming establishment front money handling system to determine if the gaming establishment account is associated with a front money account maintained by the gaming establishment front money handling system,
responsive to the gaming establishment account being associated with the front money account, authorizing, by the processor, a completion of the gaming establishment cashless transaction, wherein a difference between the first amount of funds and the second amount of funds is accessed from an amount of front money of the associated front money account, and
responsive to the gaming establishment account not being associated with the front money account and the gaming establishment account being associated with the second amount of funds that is less than the first amount of funds, denying, by the processor, a completion of the gaming establishment cashless transaction.

14. The method of claim 13, wherein responsive to the gaming establishment account being associated with the front money account, the amount of front money of the associated front money account comprises at least the difference between the first amount of funds and the second amount of funds and the gaming establishment account is associated with the second amount of funds, the authorization to complete the gaming establishment cashless transaction automatically occurs.

15. The method of claim 13, wherein the request to complete the gaming establishment cashless transaction is initiated independent of the front money account.

16. The method of claim 13, wherein the authorization to complete the gaming establishment cashless transaction occurs following a receipt of an input, via an input device, to approve an access of the amount of front money.

17. The method of claim 13, wherein the request to complete the gaming establishment cashless transaction is initiated in association with the front money account.

18. The method of claim 13, wherein the gaming establishment account comprises a cashless wagering account and the gaming establishment cashless transaction comprises a transfer of the first amount of funds to a balance of a gaming device.

19. The method of claim 18, wherein the gaming device comprises one of an electronic gaming machine and a gaming table component associated with a gaming table.

20. The method of claim 13, wherein the gaming establishment account comprises a gaming establishment retail account, and the gaming establishment cashless transaction comprises a transfer of the first amount of funds to an account associated with a point-of-sale retail terminal.
